(19) United States
(12) Patent Application Publication
(10) Pub. No.: US 2002/0067800 A1
(43) Pub. Date: Jun. 6, 2002

(54) Apparatus and method for identification of crystals by in-situ X-ray diffraction

(76) Inventors: Janet Newman, Encinitas, CA (US); Eric de La Fortelle, Cardiff, CA (US)

Correspondence Address: Pennie & Edmonds, LLP, 3300 Hillview Avenue, Palo Alto, CA, 94304, US

(21) Appl. No.: 10/042,929

(22) Filed: Oct. 18, 2001

Related U.S. Application Data
(60) Provisional application No. 60/242,034, filed on Oct. 19, 2000.

(51) Int. Cl. G01N 23/207; G01N 23/20

(52) U.S. Cl. 378/73; 378/79; 378/72

(57) ABSTRACT

The apparatus comprises a crystal growing incubator having opposing first and second sides. The apparatus also includes an X-ray system which comprises an X-ray source disposed adjacent to the first side of the crystal growing incubator and an X-ray detector disposed adjacent to the second side of the crystal growing incubator. The X-ray source is configured to irradiate crystalline material grown in the crystal growing incubator and the X-ray detector is configured to detect the presence of diffracted X-rays from crystals grown in the crystal growing incubator. The apparatus preferably further comprises a positioner that positions the incubator and the X-ray system relative to each other. Also provided is a method of screening for crystalline material in its in-situ growth environment using the above described apparatus.

### CROSS-REFERENCE TO RELATED APPLICATION

This application claims the benefit under 35 U.S.C. §119(e) of prior U.S. Provisional Application No. 60/242,034, filed Oct. 19, 2000.

### BACKGROUND OF THE INVENTION

1. Field of the Invention

The present invention relates generally to crystallography, and in particular to an automated apparatus and method for the high throughput analysis of crystals in their in-situ growth environment.

2. Description of Related Art

X-ray diffraction is a powerful technique for determining the structure of molecules. For a general review of X-ray diffraction, see B. E. Warren, X-ray Diffraction, Dover, 1990, or Cantor and Schimmel, Techniques for the Study of Biological Structure and Function, W. H. Freeman, 1980. In general, the three-dimensional structure of a molecule can be determined by observing the diffraction of a high-intensity beam of X-rays from a crystalline form of the molecule. Typically, a beam of X-rays is passed through a crystalline form of a molecule, whereafter data is collected from the unique diffraction patterns of the crystal. The diffraction data from one or more crystalline forms of the molecule can be used to calculate the three-dimensional structure of the molecule. The quality of the X-ray diffraction and, therefore, the quality of the three-dimensional structure depend on the quality of the crystalline forms of the molecule. Highly ordered, stable crystals tend to generate higher quality X-ray diffraction data.

Unfortunately, crystallization of a molecule is not a trivial task. The conditions required to grow crystals (crystallization conditions) may be dependent on many variables such as pH, buffer type, buffer concentration, precipitant, precipitant concentration, ionic strength, concentration of the molecule to be crystallized, temperature, and so forth. These crystallization conditions vary from molecule to molecule and must often be determined empirically by trial and error. In these cases, hundreds or thousands of conditions must be explored before a single candidate crystal of a molecule can be observed. For macromolecules, including proteins, crystallization can be prohibitively difficult as concentrated, highly purified solutions of macromolecules are difficult to obtain. Even then, such concentrated purified solutions often have limited stability.

Even if a first crystalline form of a molecule is obtained, there is no guarantee that this crystalline form of the molecule will diffract X-rays sufficiently well to obtain high resolution structural information. Often, the crystals are not of sufficient size or not sufficiently well-ordered to adequately diffract X-rays. Typically, researchers must laboriously optimize crystallization conditions to arrive at a crystal of sufficient quality for high-resolution diffraction of X-rays. Unfortunately, optimization of crystallization conditions is currently performed by similar trial and error techniques that are used to discover the first crystallization conditions.

To further complicate this process, crystallization conditions are not always optimized according to parameters that necessarily lead to improved X-ray diffraction. Typically, crystallization conditions are optimized to yield crystals of larger size and better visual appearance. Unfortunately, the size of a crystal and the visual appearance of a crystal are not well correlated to higher resolution diffraction of X-rays. In other words, a larger crystal does not necessarily diffract X-rays to a higher resolution than a smaller crystal. Similarly, a crystal with a superior visual appearance does not necessarily diffract X-rays to a higher resolution than a crystal with an inferior visual appearance.

Furthermore, initial crystallization experiments often yield tiny aggregates of molecules with an appearance or morphology that is difficult to identify. These particles could be poorly ordered, or amorphous, precipitate that might not be useful for further structural experiments. On the other hand, these particles could be microcrystals that satisfactorily diffract X-rays. Such microcrystals indicate initial crystallization conditions that could be optimized to yield crystals suitable for X-ray diffraction and data collection. Unfortunately, current crystallization techniques, such as visual inspection of crystals, even with the aid of a light microscope, cannot distinguish between amorphous precipitate and useful microcrystals.

Conventionally, cumbersome methods are used to investigate the actual diffraction quality of a candidate crystal. In a typical method, a candidate crystal is first removed from a crystallization solution. The delicate crystal is then transferred, usually by hand, into a capillary tube, or into cryosolution and into a cryoloop, which is placed in an X-ray beam for observation of the diffraction quality of the crystal. This relocation can easily damage the fragile crystal. What is more, such method can only be used to observe a few candidate crystals at a time.

Accordingly, there is a need in the field of crystallography for improved techniques for the systematic discovery and optimization of ideal crystallization conditions.

### BRIEF SUMMARY OF THE INVENTION

The present invention provides a method and apparatus for the identification and optimization of a crystal in-situ, i.e., in its crystallization solution. The apparatus and methods can thus be used to assess crystallization conditions without reliance upon visual inspection of a crystal and without removal of a crystal from its in-situ growth environment. Since potential crystals do not need to be removed from their in-situ growth environment, crystallization conditions can be inspected for diffracting material several times during the crystal growth period. In addition, crystals grown under different crystallization conditions can be inspected sequentially in a high throughput manner. Indeed, the method can be automated so that large numbers of crystallization conditions can be examined with minimal expense. In addition, the method and apparatus can easily be used to optimize the X-ray diffraction quality of crystals in addition to optimization of their size and visual appearance.

According to the method of the invention, a typical crystallization experiment is analyzed for crystal growth by passing an X-ray beam through a crystallization drop and assessing, through the use of a detector, whether any crystals in the drop diffract the X-rays. Diffraction indicates that a crystal has successfully grown. If no diffraction is observed, the experiment is either allowed to incubate further or ruled a failure. Moreover, the quality of the diffraction pattern may be assessed to determine the quality of the crystal and thereby optimize crystallization conditions.

Even for a small crystal or a microcrystal, the method and apparatus of the present invention provide an indication of the diffraction quality of the crystal and ideally the crystals resolution limit. Furthermore, the method and apparatus of the present invention can be used to distinguish amorphous precipitate from microcrystals, where a powder diffraction pattern of an X-ray beam by a sample is indicative of ordered microcrystals. In fact, a powder diffraction pattern produced by the method and apparatus of the present invention can even be used to assess the diffraction quality of the microcrystals.

The method and apparatus of the invention can further be used to differentiate between a protein crystal and a non-protein crystal, such as, for example, a salt crystal. This distinction may be made from, for example, analyzing the size of the crystal lattice.

As a result, the apparatus and method of the invention not only permit a determination of whether any crystal growth has taken place, by virtue of the ability to observe the quality of a diffraction pattern, but they also permit several different crystallization experiments to be compared to one another in an effort to identify optimal crystallization conditions.

The apparatus and method of the invention may be used for virtually any crystallization process known to those of skill in the art, including, but not limited to, hanging drop, sitting drop, microbatch, dialysis and gel crystallization. Moreover, the method may be readily automated, permitting the high throughput discovery of optimal crystallization conditions with minimal user input.

Accordingly, the invention provides an apparatus for detecting the presence of crystals in their in-situ growth environment. The apparatus comprises a crystal growing incubator having opposing first and second sides. The apparatus further includes an X-ray system that comprises an X-ray source disposed adjacent to the first side of the crystal growing incubator, and an X-ray detector disposed adjacent to the second side of the crystal growing incubator. The X-ray source is configured to irradiate crystals grown in the crystal growing incubator and the X-ray detector is configured to detect the presence of diffracted X-rays from crystals grown in the crystal growing incubator. The apparatus preferably further comprises a positioner that positions the incubator and the X-ray system relative to each other. An imaging system, such as an optical imaging system, is preferably disposed adjacent to the crystal growing incubator to first detect the presence and location of potential crystals grown in the incubator.

Still further, a method of screening for crystals in their in-situ growth environment is also provided. Once a potential crystal has been grown in a crystal growing incubator the crystal growing incubator is preferably coupled to a positioner. Preferably, the presence and/or location of the potential crystal in the crystal growing incubator is then optically determined using the imaging system. The location is optionally stored, and the crystal growing incubator and X-ray system are accurately aligned relative to each another based on the location of the potential crystal to ensure that an X-ray beam emitted from the X-ray source is accurately directed at the potential crystal. The potential crystal is then irradiated with the X-ray beam. If the X-ray detector detects the presence of a diffraction pattern from the potential crystal, a crystal is thereby identified and can then be screened and/or optimized for diffraction quality. In this way, potential crystals grown in the incubator can be screened for suitability by the X-ray system, thereby facilitating the increased reproducibility of successful crystal growth experiments.

Further, the apparatus and method may be used in various environments such as, for example, on earth or in space, such as, for example, in a space station or a spacecraft. An advantage of the using the present invention in space is that crystal growth can be monitored remotely. Further, remote monitoring of crystal growth may be an advantage, for example, for monitoring toxic proteins such as, for example, virus particles or bacterial toxins.

### BRIEF DESCRIPTION OF THE DRAWINGS

For a better understanding of the invention, reference should be made to the following detailed description, taken in conjunction with the accompanying drawings, in which:

FIG. 1 is a diagrammatic side view of an apparatus for screening for crystals according to an embodiment of the invention, where the apparatus is shown in partial cross-section for explanatory purposes;

FIG. 2 is a diagrammatic side view of an imaging system according to another embodiment of the invention, where the apparatus is shown in partial cross-section for explanatory purposes;

FIG. 3A is a top view of a positioner according to an embodiment of the invention;

FIG. 3B is a side view of the positioner shown in FIG. 3A, where the apparatus is shown in partial cross-section for explanatory purposes;

FIG. 4 is a flow chart of a method of screening for protein crystals according to an embodiment of the invention.

FIG. 5 is a perspective view of an another embodiment used in an experiment according to the invention; and

FIG. 6 is a X-ray diffraction image obtained using the embodiment of the invention shown in FIG. 5.

Like reference numerals refer to corresponding parts throughout the several views of the drawings.

### DETAILED DESCRIPTION OF THE INVENTION

According to the invention, the diffraction quality of a crystal or a candidate crystal can be efficiently evaluated without disturbing the crystal from its crystallization solution, i.e., growth environment. A crystallization solution can thus be screened in-situ to determine whether or not crystal growth has taken place. Where the crystallization solution is not disturbed from its crystallization environment, the crystallization solution can further incubate after an initial screen and then be screened at a later time. The crystallization solution can even be screened multiple times. Furthermore, multiple crystallization solutions can be rapidly and sequentially screened for crystal growth in a high throughput manner.

Screening can include the identification of crystalline material in one or more crystallization solutions. Screening can also include comparison of the diffraction quality of a number of crystals in a number of crystallization solutions. Such comparison can be used to, for instance, optimize the diffraction quality of crystals by assaying a number of crystallization solutions. In some embodiments of the invention, screening may also include both the identification of crystals and the comparison or optimization of diffraction quality.

The method and apparatus of the invention can be used to screen for crystals of any type of molecule. For instance, the method and apparatus of the invention can be used to screen for crystals of small molecules or macromolecules or other molecular crystals known to those of skill in the art. Suitable small molecules for the method and apparatus of the invention include, for example, small organic molecules, drugs, therapeutic molecules, antibiotic molecules, antiviral molecules, peptides, amino acids, oligonucleotides, nucleotides, sugars and other small molecules known to those of skill in the art. Suitable macromolecules include, for example, proteins, polypeptides, antibodies, enzymes, nucleic acid binding proteins, polynucleotides, DNAs, RNAs, carbohydrates and other macromolecules known to those of skill in the art.

The method and apparatus of the present invention can be used to screen crystals grown by any method of growing crystals known to those of skill in the art including, for instance, the vapor diffusion method, the hanging-drop method, the sitting drop method, the dialysis method, the microbatch method, and the gel crystal growth method. For example, native crystals can be grown by dissolving a substantially pure molecule in a crystallization solution containing a precipitant at a concentration just below that necessary to precipitate the molecule. Water can be removed from the crystallization solution by controlled evaporation to produce precipitating conditions, which are maintained until crystal growth ceases.

In one embodiment, native crystals are grown by vapor diffusion in hanging drops (McPherson, 1982, Preparation and Analysis of Protein Crystals, John Wiley, New York; McPherson, 1990, Eur. J. Biochem. 189:1-23.). In this method, the molecule and the crystallization solution are allowed to equilibrate in a closed container with a larger aqueous reservoir having a precipitation solution containing a precipitant at a concentration optimal for producing crystals. The crystallization solution is suspended as a droplet underneath a coverslip, which is sealed onto the top of the reservoir. The sealed container is allowed to stand until crystals grow.

A beam of X-rays is then passed through a crystallization solution to determine whether the solution contains crystalline material and/or to determine the diffraction quality of the crystalline material within the solution. For instance, if a solution contains a single, well-ordered crystal, or a few well-ordered crystals, a pattern of X-ray diffraction spots can be detected. If a solution contains randomly-oriented microcrystals, a powder diffraction pattern might be detected. Such a powder diffraction pattern generated by the in-situ method and apparatus of the present invention can even be used to characterize the diffraction quality of the microcrystalline material. The diffraction pattern or powder diffraction pattern correlates with the structure of the molecules comprising the microcrystals. If the X-ray beam passes through no crystalline material or if the beam passes through amorphous precipitate, no diffraction is observed.

Thus, in a method of the invention, a drop that may contain a crystal, or microcrystals, may be scanned by the X-ray beam. Those of ordinary skill in the art recognize that by using such a method, a powder diffraction pattern may indicate the presence of microcrystals or crystals.

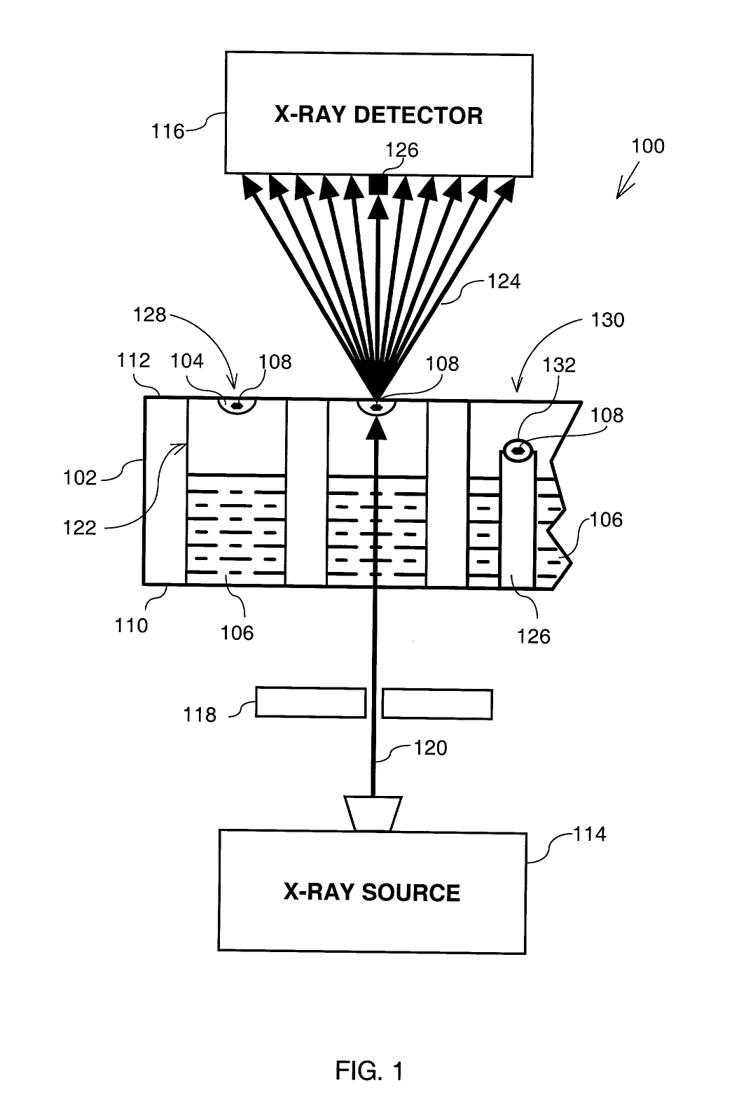

FIG. 1 is a diagrammatic side view of an apparatus 100 for screening for crystals according to an embodiment of the invention. The apparatus 100 principally comprises an incubator 102 (shown in partial cross-section for explanatory purposes), and an X-ray system comprising an X-ray source 114 and an X-ray detector 116. The X-ray system is preferably capable of resolving 1.5 Å to 3 Å.

The incubator 102, as used herein, is any apparatus in which crystals 108 can be grown. For example, the incubator 102 may be a crystallization tray or plate. The incubator thus provides an in-situ growth environment for a crystal 108. For explanatory purposes, the incubator 102 shown in FIG. 1 may be used for growing crystals using both a hanging drop 128 and a sitting drop 130 configuration, although in use, typically only one type of configuration per incubator 102 is used. Any suitable incubator 102 for growing crystals may be used, such as those disclosed in U.S. Pat. No. 5,096,676 to McPherson, or U.S. Pat. No. 5,130,105 to Carter et al., which are both incorporated herein by reference. The incubator 102 preferably comprises at least a lower or first side 110 and an opposing upper or second side 112. The incubator 102 preferably also comprises a number of wells 122 configured to hold a precipitation solution 106 for vapor diffusion. In the hanging drop configuration 128, a drop 104 of crystallization solution is applied to a glass cover slip (preferably coincident with the second side 112) and placed upside down on top of each well 122. These conditions lead to supersaturation in the drop 104 and the initiation of precipitation that forms a crystal 108.

In the sitting drop configuration 130, a drop 132 of crystallization solution is placed in a receptacle on the top of an upstanding column 126 where conditions lead to supersaturation in the drop 128 and the initiation of precipitation which forms a crystal 108.

The X-ray source 114 is preferably disposed adjacent to the first side 110 of the incubator 102, and the X-ray detector 116 is preferably disposed adjacent to the second side 112 of the incubator 102. Alternatively, the positions of the X-ray source 114 and the X-ray detector 116 may be switched, such that the X-ray detector is disposed adjacent the first side 110 and the X-ray source is disposed adjacent the second side 112.

The X-ray source 114 preferably consists of a Copper (Cu) target micro-focus X-ray tube that generates an X-ray flux of at least 5×10⁸ photons/s/mm.² This X-ray flux is necessary in order to record a diffraction pattern from the crystal 108 while it is located within its in-situ growth environment within the crystallization experiment.

In a preferred embodiment, an X-ray beam 120 is emitted upward and perpendicular to the incubator 102. The X-ray beam 120 emitted from the X-ray source 114 is preferably monochromatic and consists of CuKα radiation. The X-ray beam 120 can be of any wavelength and is preferably between about 0.5 Å and about 2.0 Å. Furthermore, the X-ray beam 120 is also preferably tightly focused and collimated to minimize any X-ray scatter that might occur as a result of X-rays reflecting from the apparatus 100. To form the tightly focused X-ray beam 120, one or more mirrors and/or collimators 118 may be provided. The collimators 118 are preferably disk shaped with circular holes extending there-through. To further aid in the accurate collection of diffracted X-rays from the crystal 108, the X-ray beam 120 is preferably less than or equal to the size of the crystal 108 being irradiated. As even the largest crystals grown for routine X-ray structure determination are generally less that 0.5 mm in size in their largest dimension, and more routinely are around 100-200 microns, the X-ray beam 120 preferably has a focus size of 200 microns or less.

In one embodiment, the X-ray source 114 is a BEDE MICRO-FOCUS (or MICROSOURCE) X-RAY GENERATOR manufactured by BEDE SCIENTIFIC INSTRUMENTS LIMITED. Micro-Mirror X-ray optics from BEDE or REFLEX are also preferably used. Alternatively, a suitable X-ray source 114 is a standard RIGAKU INTERNATIONAL CORP rotating anode generator.

Alternatively, in another lower cost embodiment, a micro-focus tube, such those made by KEVEX or FEINFOCUS, combined with a single or a dual-lens system using capillary optics from X-RAY OPTICAL SYSTEMS, and a Confocal MaxFlux multi-layer optics from OSMIC or RIGAKU, may be used. The capillary optics gather in a larger solid angle of X-rays from the source spot and the Confocal MaxFlux provides the wavelength selection and final collimation. For even lower costs, a single instead of dual focusing system can be used.

In yet another embodiment, a (non-rotating anode) mini-focus X-ray tube can be used to obtain more flux. The larger spot of the mini-focus tube at 200 watts provides a flux of 8 times that of a 25 watt microfocus tube from BEDE. In yet another embodiment, the beam size is preferably about 50 microns and the beam spot is preferably about 40 microns in diameter. In yet another embodiment, a synchrotron beam may be used.

The incident X-ray beam 120 has greater penetration than any scattered X-rays, and thus, in a vapor diffusion embodiment, the apparatus 100 is preferably set up such that the X-ray beam 120 passes through the bottom or first side 110 of the incubator 102, and through the precipitant 106 in the well 122. The X-ray beam 120 is then diffracted by any crystals 108 in its path. In this embodiment, diffracted X-rays 124 from crystal 108 pass through the upper or second side 112 of the incubator 102 and through an air gap to the detector 116, virtually unimpeded. In fact, the X-ray beam preferably can penetrate up to 1.5 mm of polystyrene and/or up to 5 mm of oil.

In the hanging drop configuration 128 the upper or second side 112 is typically a glass cover slip or mylar tape. In a microbatch embodiment under oil, the orientation of the X-ray beam relative to the incubator 102 is not critical. In the microbatch embodiment, the X-ray detector can be located adjacent the second side 112 of the incubator, i.e., above the incubator 102, and the X-ray beam could pass through a covering layer of oil and be detected by the detector 116 adjacent the first side 110 of the incubator 102, i.e., below the incubator.

The X-ray detector 116 is chosen for its sensitivity and speed and is preferably a two-dimensional detector that is sensitive to X-rays diffracted from a candidate crystal that pass through a planar surface. If a sample potentially contains microcrystals that might generate a powder diffraction pattern, the detector can be a one-dimensional or two-dimensional detector that records the position and intensity of diffracted X-rays from a candidate crystal. An ideal X-ray detector 116 preferably combines the high sensitivity of the phosphor plates with the rapid readout of a CCD camera.

Unlike other crystallography X-ray detectors, the X-ray detector 116 does not need to be large, as it does not need to resolve individual diffracted beams, but rather needs to observe the resolution limit of diffraction. Thus, a CCD camera would not require the demagnification glass taper which is needed for CCD detectors currently in use on X-ray sources. In addition, a one dimensional detector is adequate for detecting the resolution limit of diffraction, especially the resolution limit of a powder pattern.

A suitable X-ray detector should be at least as sensitive as the presently commercially available imaging plate systems, such as the phosphor plates made by FUJIFILM MEDICAL SYSTEMS U.S.A., INC (for example, the BAS 2500 NDT) which are some of the most sensitive X-ray detectors that currently exist.

However, in a preferred embodiment, the X-ray detector 116 is a cooled Charge Coupled Device (CCD) camera, which although being slightly less sensitive to X-rays than available imaging plate systems, has a very rapid readout time. Such a CCD detector is preferably mounted on a swing axis that has an imaginary center on the crystal and rotates so that the detector's input faceplate is perpendicular to the X-ray beam and can swing up to about 50 degrees from perpendicular. The CCD detector preferably includes a selected phosphor screen, with or without a fiber-optic taper front-end. The phosphor preferably achieves 4 to 8 line-pairs per millimeter resolution. In a preferred embodiment, the CCD detector is placed about 80 mm from the crystal.

In a preferred embodiment, a beam-stop 126 is provided between the incubator 102 and the X-ray detector 116 to stop a central non-diffracted X-ray beam from damaging the detector or adversely affecting the results. The spot size of the X-ray beam 120 at the detector (or beam stop) is preferably about 40 to 50 microns in diameter, with a divergence of no greater than 30 arc-seconds. A means for inserting a calibration crystal into the X-ray beam, is also preferably provided to calibrate the apparatus 100.

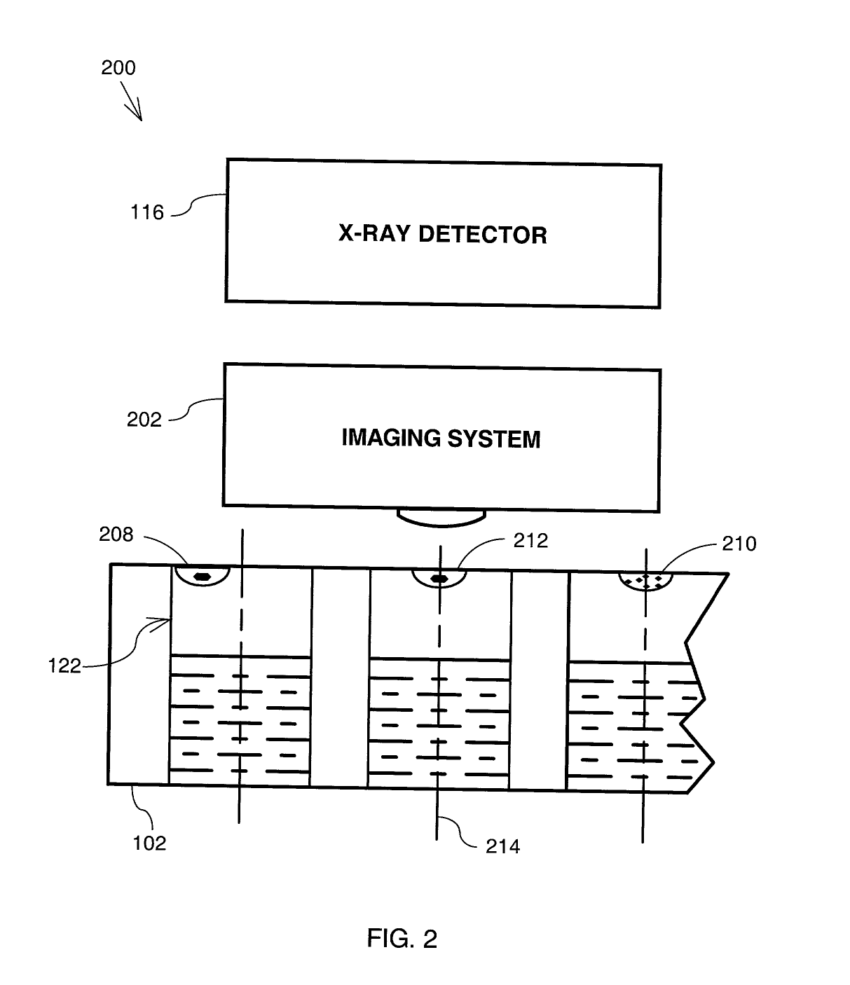

FIG. 2 is a diagrammatic side view 200 of an imaging system according to an embodiment of the invention, where the incubator is shown in partial cross-section for explanatory purposes. Due to the size of the tightly focused X-ray beam 120 (FIG. 1), the X-ray beam and the crystal 108 (FIG. 1) must align precisely in order for the crystal to precisely diffract the X-ray beam. For the hanging drop configuration 128 (FIG. 1), a crystallization drop of about 2 μL forms a hanging drop of about 1-2 mm in diameter. As mentioned above, the X-ray beam preferably has a focus size of 200 microns or less. Being that a potential crystal could be found at any position within this drop, the tightly focused X-ray beam 120 must be precisely aligned to irradiate the potential crystal. Although the utmost care is taken during setup procedures to position the drop 212 along a central axis 214 passing through the center of each well 122, the drop may shift at some time prior to irradiation, to an off-center position 208. What is more, many drops do not form sufficient crystals and only form amorphous precipitate 210. To assist in aligning the X-ray beam with a crystal, the present invention preferably employs an imaging system 202. This imaging system 202 determines whether a crystal is present in a particular well 122, and if so, determines and stores the precise location of the crystal for later alignment with the X-ray beam.

In a preferred embodiment, the X-ray system 114 and 116 (FIG. 1) is coupled to the imaging system 202. The imaging system 202 permits a rapid scan of a crystallization solution 104 (FIG. 1) for potential crystals so that each potential crystal can be identified and its location stored for later alignment with the X-ray beam 120 (FIG. 1). Use of imaging system 202, reduces the exposure of a crystallization drop to X-rays, as the crystallization drop need not be exposed to an X-ray beam until a potential crystal has been located. Further, the imaging system 202 significantly reduces the time that each crystallization solutions needs to be exposed to the X-ray beam, thereby increasing overall throughput. This is particularly advantageous, as many molecules, such as proteins and other macromolecules are sensitive to irradiation by the X-ray beam and some might even denature in an X-ray beam.

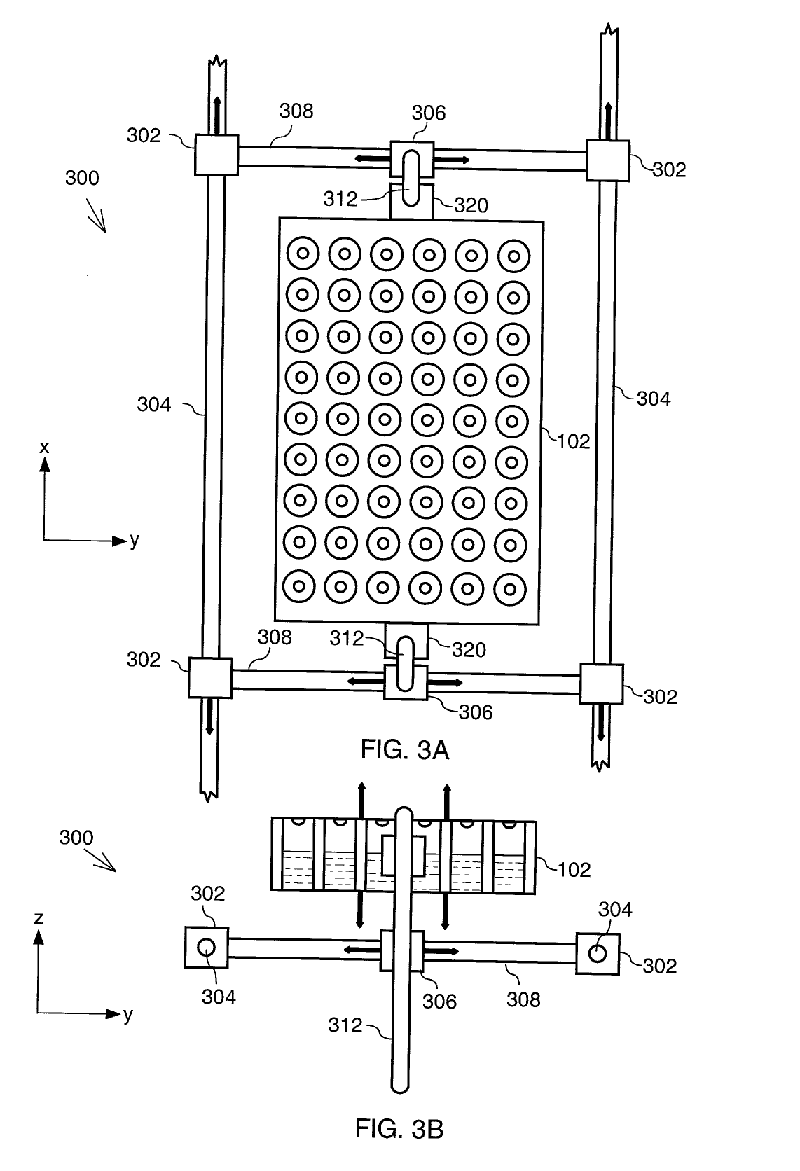

Prior to aligning the crystal and the X-ray beam, the presence and/or location of each crystal in the incubator is first determined by the imaging system 202. The presence and/or location is then stored. The stored location of each crystal is then used by a positioner (FIGS. 3A and 3B) to align each crystal and the X-ray beam relative to one another. In the preferred embodiment, the imaging system is a video imaging system, where the image capture time is on the order of a second or less for each well 122, as compared to what may be several minutes for the X-ray diffraction.

The X-ray system and the crystal preferably move relative to one another to ensure alignment of the X-ray beam and the crystal. In a preferred embodiment only the incubator 102 is moved relative to the X-ray system. In an alternative embodiment, the X-ray system, or both the X-ray system and the incubator 102 are moved relative to one another to align the crystal and the X-ray beam. This relative movement is undertaken by a positioner, which is discussed in further detail below in relation to FIGS. 3A and 3B.

FIG. 3A is a top view of a positioner 300 according to an embodiment of the invention. FIG. 3B is a side view of the positioner 300 shown in FIG. 3A, where the incubator is shown in partial cross-section for explanatory purposes. The incubator 102 is arranged on the positioner 300 which can move the incubator 102 along three perpendicular axes x, y, and z. A set of bushings 302 allow the incubator 102 to slide along parallel shafts 304 permitting translation of the incubator 102 along the x-axis. In a similar manner, bushings 306 allow the incubator 102 to slide along parallel shafts 308 permitting translation of the incubator 102 along the y-axis, while bushings 320 allow the incubator 102 to slide along parallel shafts 312 permitting translation of the incubator 102 along the z-axis. It should be appreciated that any suitable mechanism that translates the incubator 102 along any one of multiple axes may be substituted for the positioner 300 shown in FIGS. 3A and 3B. For example, the positioner may rotate the incubator about an axis instead of linearly translating it. Furthermore, in order to accurately irradiate a crystal detected by the imaging system, the positioner 300 should be accurate to within a few microns.

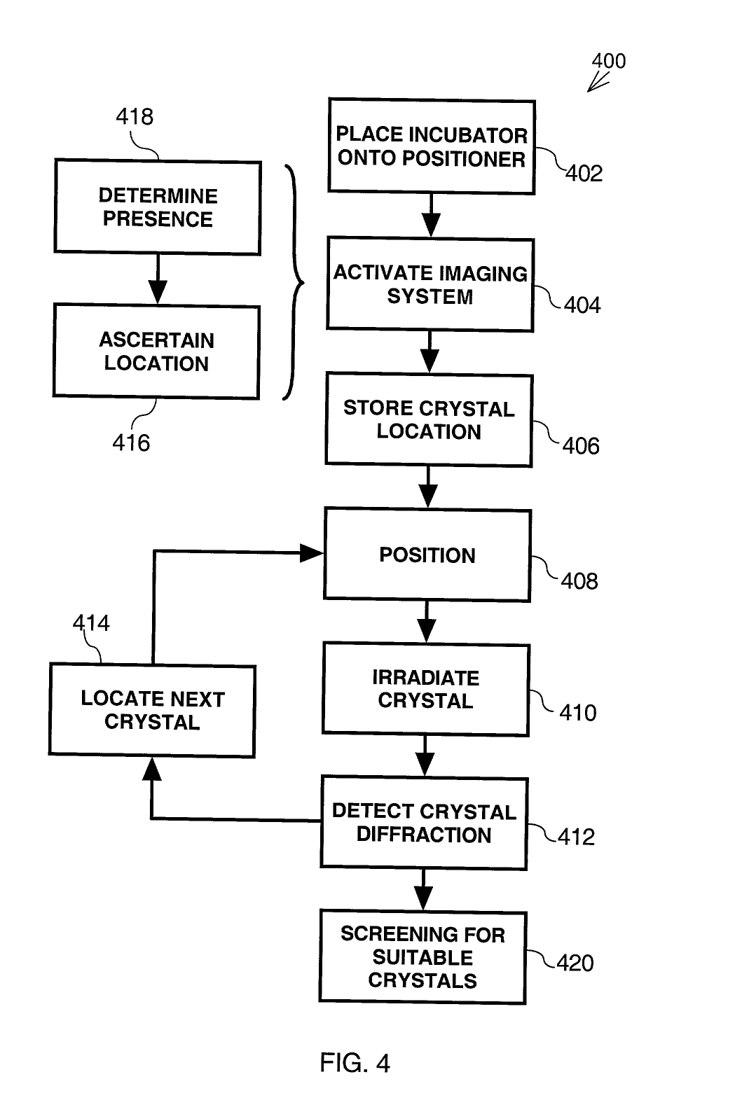

FIG. 4 is a flow chart of a method of screening for crystals according to an embodiment of the invention. The incubator 102 (FIG. 1) is preferably first placed (step 402) onto the positioner 300 (FIG. 3). The incubator 102 can conveniently be placed with a “pick and place” robot arm known to those of skill in the art. The imaging system 202 (FIG. 2) is then preferably activated (step 404) and moved over the incubator. Alternatively, the positioner can move the incubator relative to the imaging system. The activation (step 404) of the imaging system entails scanning each well 122 to determine (step 418) the presence and/or location (step 416) of a potential crystal. The imaging system 202, therefore, scans each well of the incubator for potential crystal material such as single crystals and microcrystals. The location of each visually acceptable potential crystal is then preferably stored (step 406) by the imaging system. The imaging system is then retracted from its scanning position adjacent to the incubator. Using the stored location of each potential crystal, the positioner moves the incubator 102 or the X-ray detector 116 to align or position (step 408) each potential crystal with a line coincident with the emitted X-ray beam. Each located potential crystal is then irradiated (step 410) by the X-ray beam 120 (FIG. 1) emitted from the X-ray source 114 (FIG. 1). The X-ray detector 116 (FIG. 1) detects (step 412) any diffraction from the irradiated crystal, whereafter the detected diffraction patterns are stored and/or analyzed. The positioner can optionally locate the next potential crystal (step 414) and the process can be optionally repeated until all detected crystals have been irradiated and their diffraction patterns stored and/or analyzed, where the diffraction pattern indicates the presence of one or more well ordered crystal. The overall time to assess the quality of diffraction of a single crystal is approximately 5 minutes.

Furthermore, diffraction from a microcrystalline precipitate forms a powder pattern, whereas diffraction from an amorphous precipitate only forms diffuse scatter. Acceptable powder patterns indicate that microcrystals that have successfully formed. Therefore, the system screens (step 420) for suitable crystals based on the diffraction patterns or powder patterns detected, where successful crystal growth is an indication of ideal growth conditions and can be used to refine any further crystal growth experiments.

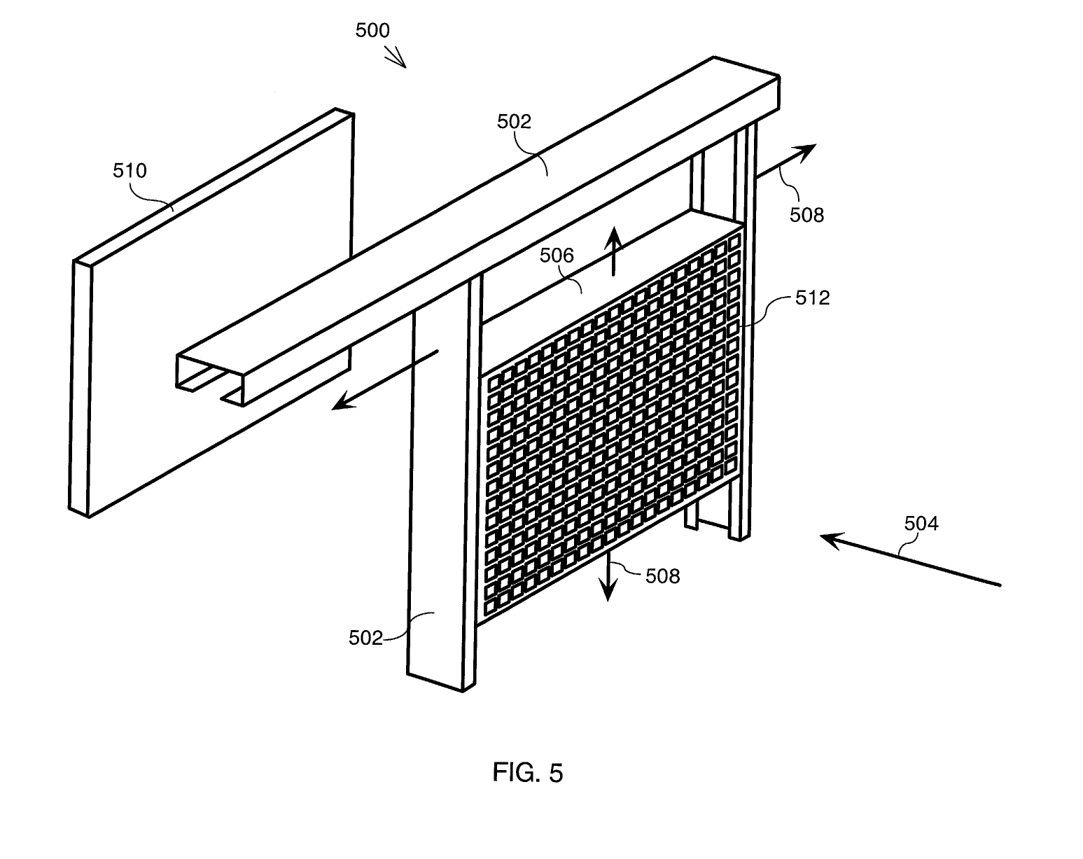

FIG. 5 is a perspective view of an another embodiment 500 used in an experiment according to the invention. A 1536 well plate 506 is secured to two mounting arms of an x-y translation device 502. Plate 506 can advantageously be positioned at any angle so that the plate can be translated, with any suitable device, in the plane perpendicular to the X-ray beam 504. The x-y translation device 502 can be used to position the plate 506 with respect to an X-ray beam 504 and a detector 510. The plate 506 can be oriented with respect to the X-ray beam 504 so that a well 512 and any potential crystals within the well 512, through which the X-ray beam 504 passes, can be identified. Diffracted X-rays are detected with detector 510.

### EXAMPLE 1

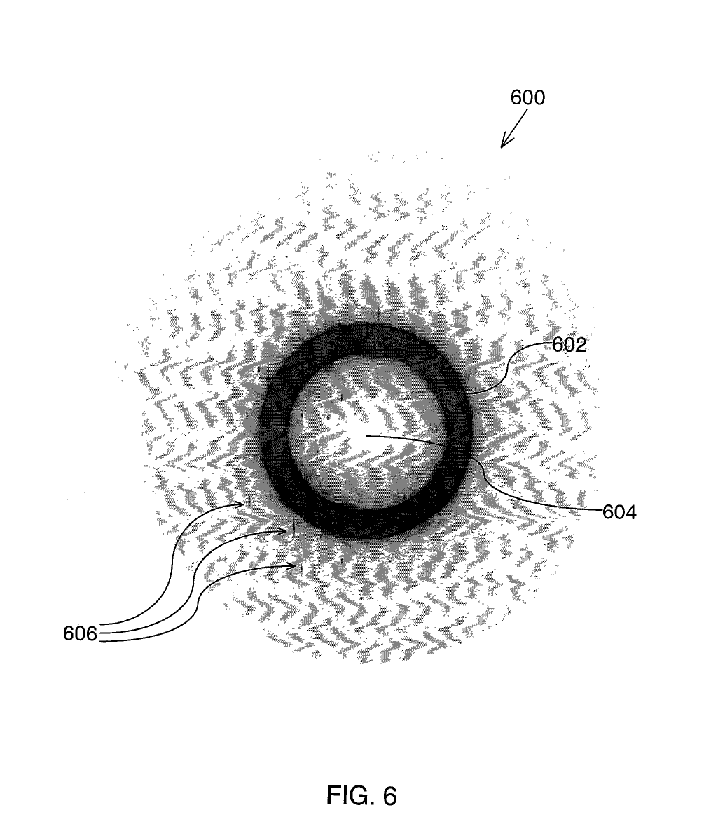

In this example, we describe the observation of X-ray diffraction from protein crystals in-situ using embodiment 500 of FIG. 5. FIG. 6 is a positive X-ray diffraction image 600 obtained from one sample using the embodiment of the invention shown in FIG. 5. Crystals of lysozyme were grown in wells 512 of a plate 506 by the microbatch method, and X-ray diffraction to 1.8 Å resolution was observed by exposing the crystals in the plate 506 to an X-ray beam 504.

The wells 512 in one corner of a Greiner 1536 well plate 506 were filled with paraffin oil (from HAMPTON RESEARCH). Each well was then injected with 400 nl of a 1:1 mixture of 60 mg/ml lysozyme in water (from SIGMA CHEMICAL CORP) and 6-10% NaCl (Sigma) in 0.1 M sodium acetate buffer, pH 4.8. The plate 506 was spun gently to coax the aqueous drops of the 1:1 mixture to the bottom of each well 512. After several days at room temperature (of about 20° C.), crystals were visible in two wells 512 of the plate 506.

Orientation of the plate 506 with respect to the X-ray beam 504 was first performed by visual alignment and then by X-ray diffraction from lead tape which was placed on the plate 506 to define an area of interest. One-second X-ray exposures were taken at 0.5 mm intervals for each well 512 of interest. In this experiment, three wells were examined. Each well was exposed four times, once in each corner of the well. Diffraction spots from one of the three wells were observed, indicating that crystalline protein was present in the well.

All exposures led to a diffraction pattern that had a band of diffuse scattering 602 (FIG. 6) which was centered around 4-5 Å resolution. This 4-5 Å band was probably due to diffraction from paraffin oil. On several, but not all, exposures, a second scattering ring centered around 8Å appeared. Since this second band appeared at exposures corresponding to approximately 2.5 mm translations of the plate, this ring was probably due to scattering from the walls of the wells of the plate which are spaced 2.25 mm apart. Some samples yielded no X-ray diffraction indicating that the X-ray beam did not pass through crystalline material. However, when the X-ray beam passed through some of the samples of lysozyme, intense diffraction patterns were observed indicating the presence of well-ordered crystals in the samples. Further exposures showed that one could observe diffraction out to 1.8 Å from the lysozyme crystal in-situ. Examples of diffraction of the crystal are referenced by numeral 606. It can also be observed that no diffraction occurs at the center 604 of the image due to placement of the beam stop 126 (FIG. 1).

Various statistical indicators may be used to determine whether a diffracting crystal or microcrystal is present in a sample. The diffraction data may be analyzed extensively, but more preferably, a simple statistical analysis, such as detecting a standard deviation within the image, would be sufficient. One of ordinary skill in the art may, without undue experimentation, determine the threshold of standard deviation that would be appropriate to indicate the presence of crystals or microcrystals.

Thus, the method and apparatus of the present invention can be used to detect the presence of crystalline forms of molecules in-situ. In particular, determining whether a detected crystalline material is a protein crystal or a salt crystal. Furthermore, the resolution of the diffraction of crystalline material can be determined quantitatively.

Further, the apparatus and method may be used in various environments such as, for example, on earth or in space, such as, for example, in a space station or a spacecraft. In this embodiment, a transmitter that transmits information associated with said diffraction pattern to a remote location is also provided. The transmitter may be any suitable transmitting means, such as radio, satellite, microwave, or the like. An advantage of the using the present invention in space is that crystal growth can be monitored remotely.

While the foregoing description, drawings and example represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description. All patents and publications disclosed herein are hereby incorporated by reference in their entirety.

What is claimed is:

1. An apparatus for detecting the presence of crystalline material in its in-situ growth environment, comprising:
a crystal growing incubator having opposing first and second sides;
an X-ray system, comprising:
an X-ray source disposed adjacent to said first side of said crystal growing incubator, where said X-ray source is configured to irradiate crystalline material grown in said crystal growing incubator; and
an X-ray detector disposed adjacent to said second side of said crystal growing incubator, where said X-ray detector is configured to detect the presence of diffracted X-rays from crystalline material grown in said crystal growing incubator; and
such that in use, crystalline material grown in said incubator can be screened for suitability by said X-ray system, thereby, facilitating the increased reproducibility of successful crystal growth experiments.

2. The apparatus of claim 1, further comprising a positioner that positions said incubator and said X-ray system relative to each other.

3. The apparatus of claim 1, wherein said crystal growing incubator is a sample holding tray that is configured to grow crystals therein.

4. The apparatus of claim 1, further comprising an imaging system disposed adjacent to said crystal growing incubator, where said imaging system detects the presence and location of crystals grown in said incubator, such that in use an X-ray beam emanating from said X-ray source is accurately aligned with crystals detected by said imaging system.

5. The apparatus of claim 1, wherein said X-ray detector is selected from a group consisting of: a charged coupled device (CCD) camera and an imaging plate system.

6. The apparatus of claim 5, wherein said imaging plate system is a phosphor plate imaging system.

7. The apparatus of claim 1, wherein said X-ray detector comprises a detector that provides high sensitivity and a rapid readout.

8. The apparatus of claim 1, wherein said X-ray source emits a monochromatic beam of X-rays consisting of CuKα radiation.

9. The apparatus of claim 1, wherein said X-ray source emits an X-ray beam with a focus size of 200 microns or less.

10. The apparatus of claim 1, further comprising a transmitter that transmits information associated with said diffraction pattern to a remote location.

11. A method of screening for crystalline material in its in-situ growth environment, said method comprising the steps of:
irradiating crystalline material in its in-situ growth environment with an X-ray beam;
detecting a diffraction pattern from said crystalline material; and
screening said crystalline material for suitability based on said diffraction pattern.

12. The method of claim 11 wherein the crystalline material is comprised of a group consisting of: a crystalline powder, a microcrystal, a single crystal, and a plurality of single crystals.

13. The method of claim 11 wherein the diffraction pattern is comprised of a group consisting of: a powder diffraction pattern and a pattern of X-ray diffraction spots.

14. The method of screening for crystalline material according to claim 11, further comprising, prior to said irradiating, positioning said crystalline material and said X-ray beam relative to each another, such that said X-ray beam accurately aligns with said crystalline material.

15. The method of screening for crystalline material according to claim 11, further comprising, prior to said irradiating, determining the presence of said crystalline material in said in-situ growth environment.

16. The method of screening for crystalline material according to claim 15, further comprising ascertaining the location of said crystalline material in said in-situ growth environment.

17. The method of screening for crystalline material according to claim 16, further comprising storing the location of said crystalline material.

18. The method of screening for crystalline material according to claim 17, further comprising positioning said crystalline material and said X-ray beam relative to each another based on the location of said crystalline material, such that said X-ray beam accurately aligns with said crystalline material.

19. The method of screening for crystalline material according to claim 11, further comprising, prior to said irradiating, positioning said crystalline material and said X-ray beam relative to one another, such that said X-ray beam can accurately irradiate said crystalline material.

20. The method of screening for crystalline material according to claim 11, wherein said method further comprises the initial step of growing crystalline material in a growth environment.

21. The method of screening for crystalline material according to claim 20, wherein said growing further comprises producing crystalline material in said growth environment by a method selected from a group consisting of: a vapor diffusion method, a hanging-drop method, a sitting drop method, a dialysis method, a microbatch method, and a gel crystal growth method.

22. The method of claim 11, wherein said method is performed in space.

23. The method of claim 11, further comprising determining whether said crystalline material is a protein crystal.

24. The method of claim 11, further comprising determining whether said crystalline material is a salt crystal.

25. A method of screening for crystalline material in its in-situ growth environment, said method comprising the steps of:
growing crystalline material in a crystal growing incubator;
placing said crystal growing incubator into a positioner;
determining the presence of said crystalline material in said crystal growing incubator;
ascertaining the location of said crystalline material in said crystal growing incubator;
storing the location of said crystalline material;
positioning said crystal growing incubator and an X-ray source relative to each another based on the location of said crystalline material, such that an X-ray beam emitted from said X-ray source accurately aligns with said crystalline material;
irradiating said crystalline material with said X-ray beam;
detecting with a X-ray detector, a diffraction pattern from said crystalline material; and
screening said crystalline material for suitability based on said diffraction pattern.

26. The method of claim 25 wherein the crystalline material is comprised of a group consisting of: a crystalline powder, a microcrystal, a single crystal, and a plurality of single crystals.

27. The method of claim 25 wherein the diffraction pattern is comprised of a group consisting of: a powder diffraction pattern and a pattern of X-ray diffraction spots.

28. The method of claim 25, wherein said crystalline material is re-positioned relative to said X-ray beam while said X-ray beam remains stationary.

29. The method of claim 25, wherein said method is performed in space.

30. The method of claim 25, further comprising determining whether said crystalline material is a protein crystal.

31. The method of claim 25, further comprising determining whether said crystalline material is a salt crystal.
